(19) United States
(12) Patent Application Publication
(10) Pub. No.: US 2007/0033194 A1
(43) Pub. Date: Feb. 8, 2007

(54) System and method for actively managing service-oriented architecture

(76) Inventors: Davanum M. Srinivas, Sharon, MA (US); Leo F. Parker, Ocean Springs, MS (US); Igor S. Sedukhin, Issaquah, WA (US); Dmitri Tcherevik, Setauket, NY (US); Vlad Umansky, Newton, MA (US)

Correspondence Address: BAKER BOTTS L.L.P., 2001 ROSS AVENUE, SUITE 600, DALLAS, TX, 75201-2980, US

(21) Appl. No.: 11/333,481

(22) Filed: Jan. 17, 2006

Related U.S. Application Data
(63) Continuation of application No. 11/134,072, filed on May 20, 2005, now abandoned.
(60) Provisional application No. 60/573,565, filed on May 21, 2004.

(51) Int. Cl. G06F 17/30

(52) U.S. Cl. 707/10

(57) ABSTRACT

A method for managing policy in a service-oriented architecture includes intercepting a communication representing a transaction between a client and a service along a network, interpreting the communication to determine details of the transaction, determining if the transaction complies with policy based on the details of the transaction and remediating where the transaction is determined to not comply with the policy.

### REFERENCE TO RELATED APPLICATION

The present application is based on and claims the benefit of provisional application Ser. No. 60/573,565, filed May 21, 2004, the entire contents of which are herein incorporated by reference.

### TECHNICAL FIELD

The present disclosure relates to service-oriented architecture and, more specifically, to actively managing service-oriented architecture.

### DESCRIPTION OF THE RELATED ART

Service-oriented architecture (SOA) is a software architectural concept that features a collection of nodes on a network that may offer to perform a service, for example, to make a resource available. Users may then be able to identify and utilize an available service.

SOA may include loosely jointed, highly interoperable application services. Cross-platform compatibility is a central concept of the SOA and therefore various different technologies may be employed by application services and users who may seek to access these services. Examples of popular platforms utilized in offering and gaining access to services include Java Enterprise System from Sun Microsystems and Indigo Application Server from Microsoft.

Web services are commonly implemented using SOA. Web services are services and offerings that are made available over private intranets and the Internet by various providers. Web services may allow customers to directly access the services of providers thereby allowing providers to create new sources of revenue, reduce operating costs and/or improve customer support services.

The cross-platforn compatibility of SOA makes it convenient for customers and providers to utilize and offer web services using a wide range of equipment. To enable cross-platform compatibility, sets of standards may be adopted. Examples of standards used include XML, HTTP, SOAP, WSDL and UDDI.

Corporations often rely on corporate policy to direct the actions of employees and resources according to the vision of corporate management. Corporations have traditionally relied on an employee hierarchy for managing corporate policy. For example, the common practice of requiring a manager's signature on a purchase order of a particular value and requiring a vice president's signature on a purchase order of a greater value may serve to help align the purchasing activities of the corporation with corporate goals by creating oversight and accountability.

However, traditional corporate policy may only be effective when followed. Ultimately, it may be very difficult to prevent policy violations from occurring in the first place. Additionally, as corporations adopt web services, traditional approaches to policy management may be difficult to implement or may serve to reduce the efficiency of web services.

It would therefore be desirable to utilize a method and system for policy-based management and security of web services over a service-oriented architecture.

### SUMMARY

A method for managing policy in a service-oriented architecture includes intercepting a communication representing a transaction between a client and a service along a network, interpreting the communication to determine details of the transaction, determining if the transaction complies with policy based on the details of the transaction and remediating where the transaction is determined to not comply with the policy.

A system for managing policy in a service-oriented architecture includes a policy client sensor for intercepting a communication representing a transaction between a client and a service along a network, a policy engine for interpreting the communication to determine details of the transaction and determining if the transaction complies with policy based on the details of the transaction and a policy client actuator for remediating where the transaction is determined to not comply with the policy.

A computer system includes a processor and a computer recording medium including computer executable code executable by the processor for managing policy in a service-oriented architecture. The computer executable code includes code for intercepting a communication representing a transaction between a client and a service along a network, code for interpreting the communication to determine details of the transaction, code for determining if the transaction complies with policy based on the details of the transaction and code for remediating where the transaction is determined to not comply with the policy.

A computer recording medium including computer executable code for managing policy in a service-oriented architecture. The computer executable code includes code for intercepting a communication representing a transaction between a client and a service along a network, code for interpreting the communication to determine details of the transaction, code for determining if the transaction complies with policy based on the details of the transaction and code for remediating where the transaction is determined to not comply with the policy.

### BRIEF DESCRIPION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating a system for actively managing SOA according to an embodiment of the present disclosure;

FIG. 2 is a block diagram showing an example of the relation between available data and policy management according to an embodiment of the present disclosure;

FIG. 3 is a block diagram illustrating a system for performing embodiments of the present disclosure;

FIG. 4 is a block diagram showing SLA negotiation according to an embodiment of the present disclosure;

FIG. 5 is a flow chart illustrating a method for managing policy in a service-oriented architecture according to an embodiment of the present disclosure; and

FIG. 6 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

As described above, corporate policy may be used to align the actions of employees with the vision of corporate management. For example, policy may be used to maintain order, security, consistency or other ways of successfully furthering a goal or mission.

Embodiments of the present disclosure utilize a significantly more expansive definition of policy. Policy according to embodiments of the present disclosure may include rules, security precautions, monitoring, retrospective and contemporaneous enforcement, structural changes and any other concept that may serve to align the actions of corporate employees and corporate resources with the directives of corporate management.

Rules may be a set of conditions that result in particular actions. Rules may be executed by employees or may be automated. An example of a rule may be that purchase orders over a certain value must be authorized by a vice president. Security precautions may be actions that are taken to protect the corporation, its computer systems and personnel from being somehow compromised. An example of a security precaution may be the use of a firewall or the use of antivirus applications. Monitoring may be the collecting of data that may indicate compliance with policy. For example, data may be collected relating to placed purchase orders to determine the extent to which policy has been complied with. Retrospective enforcement may provide for remedial measures in the event that monitoring indicates that policy has not been properly complied with. Examples of retrospective enforcement may include the canceling of non-compliant purchase orders. Contemporaneous enforcement may be closely related to enforcement. Contemporaneous enforcement may relate to the prevention of actions that are non-compliant with policy. For example, a purchasing system may refuse to accept a purchase order for a supplier that is not on a list of approved suppliers. Policy may implement structural changes to control what options are available to employees and resources. For example, policy may limit which web services may be discoverable thereby preventing the discovery and utilization of undesired web services.

Embodiments of the present disclosure may be used by an organization that may make use of web services and/or be used by an organization that may offer web services. Although many of the examples presented in this disclosure illustrate utilization of embodiments of the present disclosure by an origination that uses web services, it is to be understood that these embodiments may also be applied to other organizations.

Embodiments of the present disclosure may be implemented to manage and enforce corporate policy, particularly as it relates to the utilization of services across a SOA, and particularly, as it relates to the utilization of web services.

Service-oriented architecture (SOA) may be thought of as a blueprint to a ubiquitous message-based application infrastructure well suited for business processes, IT systems and software production integration. An application called a service may be capable of accepting messages formed according to service description, and an application called a client may discover service descriptions and send properly formed messages to the service. In this way, a client and a service may interact.

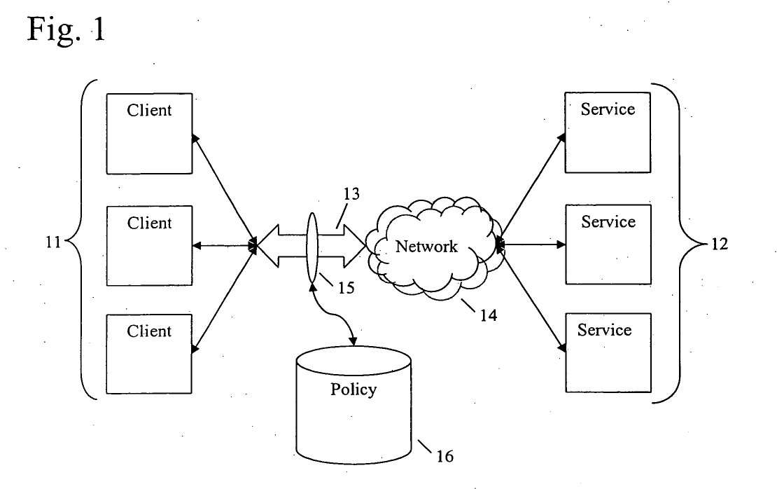

FIG. 1 is a block diagram illustrating a system for actively managing SOA according to an embodiment of the present disclosure. There may be one or more clients 11 within an organization, for example a corporation. A client 11 may be a system under the control of a consumer, for example a corporate employee. For example, a client 11 may be a web browser executed by an employee. The clients 11 may be connected to a secure network backbone 13. This secure network backbone 13 may be, for example, a local area network (LAN) and/or a virtual private network (VPN). The secure network backbone 13 may allow for the clients 11 to discover and/or connect with one or more services 12 across a network 14, for example a wide area network (WAN) and/or the Internet. The services 12 may be offered by one or more providers.

Interactions between the clients 11 and the services 12 may be ordered message exchanges, for example, request-reply exchanges. Each message may be formed according to a schema expressed in a service description. Individual messages may be encrypted and/or signed. Messages may be expressed in XML conforming to SOAP application protocol and sent using HTTP network transport protocol.

Each client 11 may include proper identity representation in the interactions (e.g. using WS-Security in SOAP messages). Consumers may maintain a repository of identities and groups (e.g. LDAP directory, distributed certificate key stores) from which the client can pick up necessary identity representation. In many cases it may be transparent to the actual client implementation. For example, platform APIs could be used to retrieve public X.509 certificate of the user.

One or more policy agents 15, for example, observer/enforcers may be installed to monitor service traffic along the backbone 13. The policy agents 15 may be equipped to interpret service traffic, for example by monitoring request-reply exchanges. The policy agents may have sensors and actuators that may understand and execute management and security policy. These policies may include instructions to invoke management operation based on rules and events. A policy engine may be used to gather data from the environment/infrastructure and external sources (for example, web services) to decide the sequence of actions to be executed.

According to an embodiment of the present disclosure, the policy agents 15 may passively collect data to be used to assess policy compliance. According to another embodiment of the present disclosure, the policy agents 15 may actively participate in the request-reply exchanges to implement contemporaneous enforcement of policy, for example as read from a policy database 16.

For example, policy agents may be able to block instructions to web services that do not conform to policy. Policy agents may also be able to rework instructions to web services so that they conform to policy. Where policy has been violated, policy agents may be able to generate an alert to appropriate personnel.

Consistent with the broad definition of policy described in the present disclosure, policy agents may implement a network efficiency optimization policy. For example, policy agents may be able to implement load-balancing and failover. This may be particularly useful when utilized by service providers. Other actions that may be performed by policy agents would be the prevention of denial of service attack and the location and removal of malicious programs.

In addition to observer/enforcers located on the network backbone, policy agents may interface with various corporate databases and systems or any other corporate system that may allow for access to data that may serve as conditions for the execution of policy. Examples of interfaced systems may include messages and logs, identities and groups, resources and states, and metrics and availability.

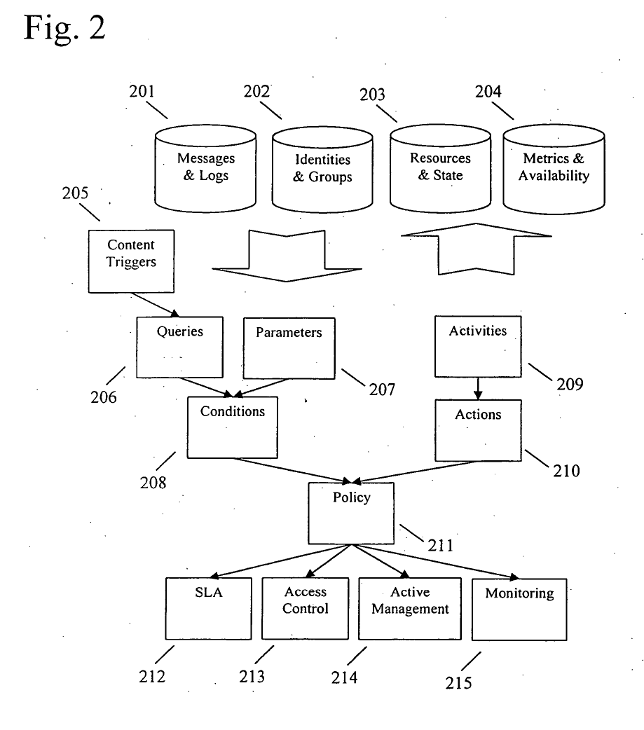

Data available from these sources may then be utilized in ascertaining the conditions that policy relates to. FIG. 2 is a block diagram showing an example of the relation between available data and policy management according to an embodiment of the present disclosure. Data may be utilized from one or more databases. Examples of databases that may be utilized include a database of messages and logs 201, a database of identities and groups 202, a database of resources and states 203 and a database of metrics and availability 204. This data may be drawn upon, for example, to assess conditions 208. For example, conditions may include applying various queries 206 to various parameters 207. The parameters, for example, may be drawn directly from the databases 201-204. The queries 206 may include content triggers that may be used, for example, to initiate queries 206.

In addition to checking to see if conditions 208 have been satisfied, policy 211 may include the performance of one or more actions 210. Actions 210 may be performed in response to conditions 208. Actions 210 may implement activities 209 that may perform changes on the data stored in the databases 201-204. For example, a database of identities and groups 202 may contain data pertaining to an employee buyer. The buyer may use a web service to place an $11,000 order. A content trigger defined as “order.total>$10K” may be triggered. A query defined as “approval=VP” may be initiated by the content trigger. The parameter “approval” may be retrieved from the Identities & Groups database 202. The content trigger, the query and the parameters may form the conditions. The conditions may call for an action 210 such as to “allow” the order. The action may trigger an activity 209, for example, to record the transaction in the messages and logs database 201.

Policy 211 may also initiate external actions such as, for example, to monitor SLA 212 compliance, control access 213, manage activity 214, perform monitoring 215, etc. In the example above, in addition to triggering the action “allow”, policy 211 may exert access control 213 in allowing the transaction to complete.

Policy 211 components, for example, content triggers 205, queries 206, parameters 207, conditions 208, activities 209 and actions 210 may be expressed using any computer language. For example, policy components may be formed in the C language. Alternatively, policy components may be expressed using a user-readable language, for example XML. Policy may be programmed directly or via a user interface that allows for user-friendly access to editing policy. Policy may be constructed according to available standards such as, for example, XACML, WS-Policy, XPath, XQuery, SAML, BPEL4WS, WS/OGSI-Agreement, etc.

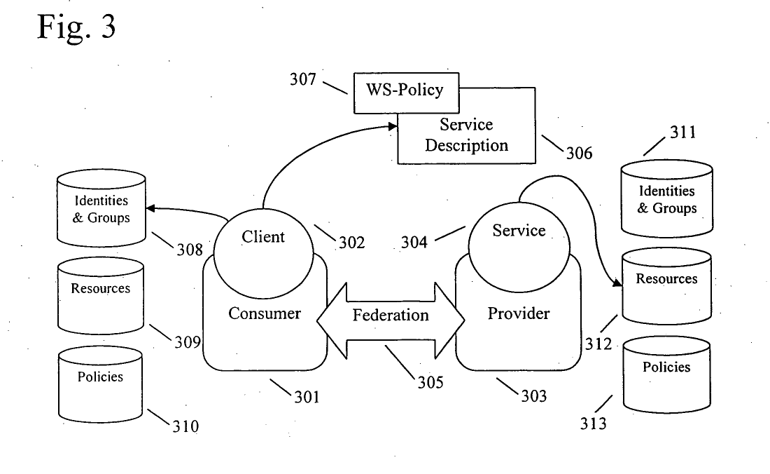

FIG. 3 is a block diagram illustrating a system according to embodiments of the present disclosure. A consumer 301 may utilize a client 302 for interfacing with a web service 304 provided by a provider 303. The provider 303 may own the service 304 and the consumer 301 may own the client 302. A service may be a client to another service and a client may be a service to another client. One or more clients 302 and one or more services 304 may together form a federation 305. A federation may be a grouping of clients and services wherein resources and/or authentication credentials may be shared. For example, a service may allow for the utilization of affiliated services without the need for a client to re-authenticate to the affiliated service.

Consumers 301 may discover service descriptions 306 (for example a WSDL document and/or WS-Policy 307) and instantiate a client 302. This may be performed dynamically or statically. For example, a client may be a specific realization of an intention to use some of the service's functions. A client, for example, could be a Microsoft NET Windows Forms application or a BPEL4WS business process. Discovery may happen in many ways. For example, a UDDI directory may be queries, a web portal, for example Google may be searched, and/or a WSDL document location may be manually entered into an application development tool. After discovering and reading the service description, the client may have an understanding of how to properly form and send messages to interact with the service.

The provider may be responsible for making the service description available to consumers. The provider may also offer a service to implement necessary functionality and accept messages formed according to the description. A service may be, for example, a specific realization (for example a J2EE web application) of the provider's intent to offer certain functionality to customers.

The client 302 may include identity representation in the interactions (for example using WS-Security in SOAP messages). The consumer may maintain a repository of identities and groups 308, for example an LDAP directory and/or distributed certificate key stores. The client may access the repository of identities and groups 308 to obtain necessary identity representations to access the desired service 304. The storage and use of these identities and groups may be transparent to the client implementation. For example, platform APIs could be used to retrieve a public X.509 certificate of the current user.

The provider 303 may publish policy descriptions (for example, a WS-Policy Document or attachment to a WSDL document) to inform clients of service requirements, for example, what identity representation to use in interactions and/or which token service to use to acquire a temporary identity representation.

Depending on the particular service being offered, the identity of the client may be required by the service. For other services, the identity of the client need not be known. For example, an intermediary service, a service broker and an aggregate service may not require the identity of the client. However, an opaque identity representation may be required for using a secure service, for example, to perform an audit, provide proof of use, etc.

Providers may also maintain a repository of identities and groups 311. If the provider requires the identity of the client, the consumer may sign up with the provider and create an account. The provider may then maintain the identity of clients. The provider may then use registration information, for example a user name and password, to grant that client access to the service. Alternatively, a consumer may use a common identity and group repository to authenticate to the provider. For example, a Microsoft Passport or Liberty-compliant third party identity management service may be utilized. This approach may be particularly suited for smaller providers who may not want the burden of managing user credentials. Alternatively, the consumer and the provider may form a federation thereby exchanging and mapping identities between each other. For example, WS-Federation may be used to establish a federation. This approach would allow both the consumer and provider to maintain their own internal identity and would be able to map to the corresponding repository of the other party when desired.

The consumer may maintain internal resources 309. Similarly the provider may maintain internal resources 312. The resources of the provider 312 may be considered to be the external resources of the consumer. The consumer may gain access to the resources of the provider by way of the provider's service 304.

The consumer may maintain policies 310 according to embodiments of the present disclosure. Similarly, the provider may maintain policies 313 according to embodiments of the present disclosure. The policies of the consumer and provider may seek to advance the goals of that particular organization as described in detail above. However, when an interaction between consumer and provider occur, the policies of both parties may be in effect. Policies may be programmed to interpret service descriptions to determine an expected content schema. For example, the following XML schema fragment may allow for the recognition, for example by a policy agent, that the “order” has a “total.”

<element name= “order”>

<complexTypes>

. . .
<sequence>

<element name=“total” type=“decimal”/>

</sequence>
. . .

</complexType>

</element?

Moreover, because messages may be XML-based (or alternatively XML InfoSet-based), it may be possible to define policies relating to content with a schema that is not known in advance. For example, the following XML fragment may be verified against an “order.total>$10K and approveBy=‘VP’” condition.

. . .
<o:order>

<o:total>20000</o:total>

<o/o:order>
<x:appeoveBy>VP</x:approveBy>
. . .

XML may provide for flexibility in mixing (composing) content and allowing applications to process only what they know about. In the example above, applications that know how to process orders may understand elements in the “o” namespace and applications that know how to process approvals may understand elements in the “x” namespace. Therefore, policy conditions against the content of the messages may be generalized. For example, the following is an XPath expression that matches the earlier mentioned condition against the XML fragment regardless of the namespace of order elements.
(./order/total>10000) and (./x:approveBy=“VP”)

Policies may play a key role in the management of interactions (for example message exchange) between clients and services. For example, access control policies may define who can use which service's functions and under what conditions. Authentication policies may specify which service's functions require known identities. Service level agreement (SLA) policies may require the service to perform well with respect to well-behaving clients. Corporations may apply SPA according to embodiments of the present disclosure to ensure that interactions comply with policies which reflect business objectives, priorities and regulations of the corporation.

Service level agreements (SLAs) may be an example of policy according to an embodiment of the present disclosure. An SLA may define conditions on which a client may use a service and/or may specify what degree of performance is expected of the service. SLAs may be tightly associated with client identities, descriptions of services as a resource, performance characteristics, usage accounting, billing and charge back. For example, an SLA may be that “premium clients can place orders between 9 am and 4 pm at a rate of less than 10 requests per second and the reply is guaranteed in less than a second.”

Policy may be used to determine if compliance to SLA has occurred. In order to interpret the SLA, its terms should be understood. In the example SLA shown above, user groups may be consulted to determine which clients are “premium.” Message exchange may be monitored, for example by a policy agent, to identify messages indicating order placement and fulfillments. Terms such as “start time,” “end time,” “request rate,” “reply duration” may be predefined, for example, within the SLA, or alternatively associated with client identities and/or resources.

The terms of SLAs may be negotiated between consumers and providers. Providers may maintain SLAs for various clients and/or client groups. Both consumer and provider may monitor and enforce SLA as part of its policy. In so doing, each party may seek to enforce its own interest. For example, SLAs may specify monetary payments (charge backs) that may come due in the event that a service fails to meet the SLA requirements. Consumer policy may therefore be setup to monitor and enforce SLA violation charge backs. For example, provider policy may seek to prevent SLA violations from occurring and/or solve problems that have caused or are likely to cause an SLA violation.

Embodiments of the present disclosure may automatically engage in SLA negotiation to arrive at an SLA that complies with policy. This may occur automatically, for example, when a new service is discovered and accessed by a client. The client and/or consumer may instantiate and/or negotiate an SLA with the provider and/or service, for example, using standard negotiation protocols such as, for example, ES/OGSI-Agreement. Instantiating the SLA could also be done manually, for example by a graphic user interface (GUI). For example, signing up for an email account may include a selection of predefined SLAs, for example, free, premium, etc. More sophisticated SLA conditions (for example charge back modes) may also be manually negotiated.

Similarly, SLAs may be renegotiated between the consumer/client and the provider/service. Renegotiation may be manual or automatic.

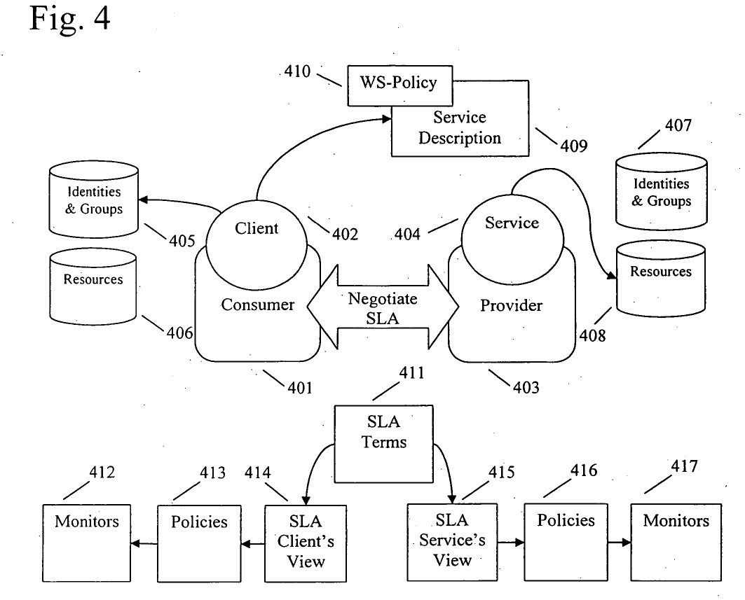

FIG. 4 is a block diagram showing SLA negotiation according to an embodiment of the present disclosure. A consumer 401 may form a client 402. The client may utilize databases of identities and groups 405 and/or additional resources 406 to utilize the resources 408 of a service 404 owned by a provider 403. Discovery may be performed based on a service description 409 and/or a WS-Policy 410. The service 404 may authenticate the client 402 based on the service's database of identities and groups 407. SLA negotiation may then take place between the consumer/client and the provider/service. During this negotiation, SLA terms 411 may be included by either party. The client may have an SLA client view 414 that may offer SLA terms and/or accept/reject offered SLA tenns based on policy 413 and monitors 412. Similarly, the service may have an SLA service view 415 that may offer SLA terms and/or accept/reject offered SLA terms based on policy 416 and monitors 417.

To expedite and/or simplify SLA negotiation, consumers may retrieve standard SLA templates from the provider. The provider may publish these standard SLA templates and describe the details of the various SLA templates, for example, conditions that apply to premium clients. SLA negotiation may then comprise a client choosing from among the available SLA templates. This may facilitate the automated processing of client-service interactions. This process may be similar to the way a WSDL document may facilitate automated processing of message exchanges.

Similarly, clients may be able to request complete SLAs from the service. For example, WS-Policy could be used to convey complete SLA documents. A WS-Policy profile for SLAs (for example, WS-SecurityPolicy) may be used. Standard SLA terms may be used in the WS-Policy expressions. Such SLA documents may be polished standing alone, registered in a UDDI as tModels, and/or attached to WSDL documents describing services.

Consumers and providers may know which SLAs apply to which identities and services. Both parties may be able to find sufficient information in service descriptions and interactions. Each party may maintain its own database of identities 406 and 407 and resources 406 and 408.

Negotiated SLAs may then be translated into policies. Policies may then utilize policy agents, for example monitors, to verify proper SLA compliance. It is possible that the same SLA may be translated into a different set of policies by each party. At runtime, monitors may examine incoming and outgoing interactions (for example, message exchanges) between client and service and evaluate compliance to the policies. Actions may be taken, alerts raised, and problems fixed, according to the policies.

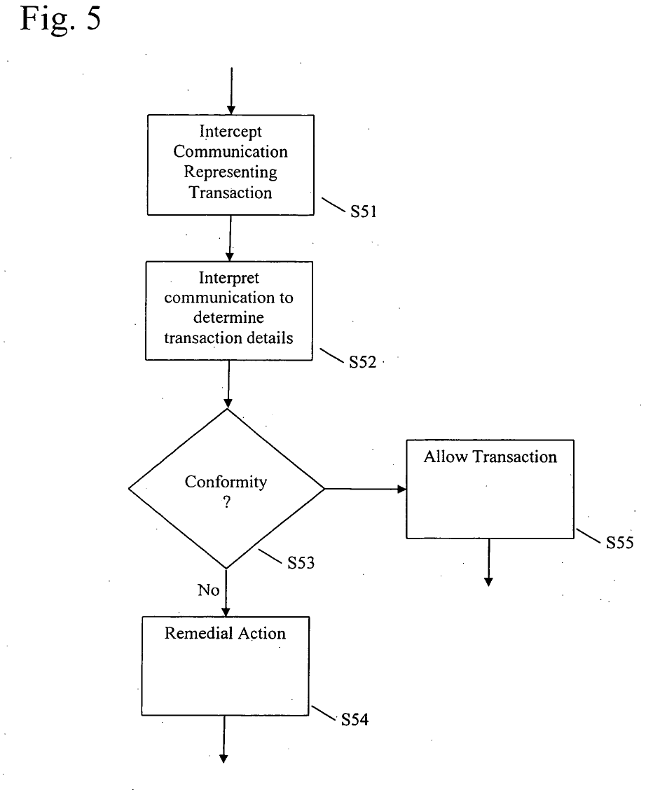

FIG. 5 is a flow chart illustrating a method for managing policy in a service-oriented architecture according to an embodiment of the present disclosure. A policy agent sensor may intercept a communication representing a transaction (for example a web service transaction) between a client (for example a client under the control of a consumer) and a service (for example a service offered by a service provider along a network (for example a secure network backbone)) (Step S51). The communication may be an ordered message exchange, for example adhering to communications standards such as, for example, XML, SOAP and/or HTTP. The policy agent sensor may interpret the communication to determine details of the transaction (Step S52). It may then be determined, for example by a policy engine, whether the transaction is in conformity with policy (Step S53). The policy may include management policy, security policy and/or any form of policy such as, for example, those aspects of policy discussed above. Where the transaction is determined to not be in conformity with the policy (No, Step S53), remedial actions may be taken (Step S54), for example by a policy agent actuator. Remedial action may include, for example, blocking the transaction, logging the instance of the policy breach, and/or modifying the transaction. This may include participation in request-reply exchange of the communication. Where the transaction is determined to be in conformity with the policy (Yes, Step S53), the transaction may be allowed to proceed (Step S55).

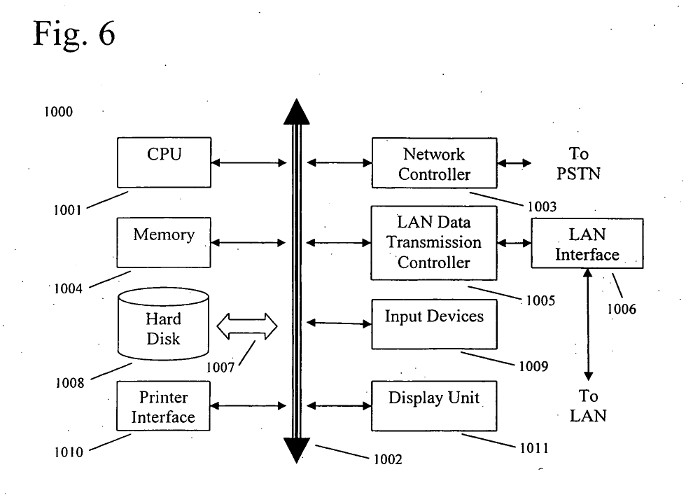

FIG. 6 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for managing policy in a service-oriented architecture, comprising:
intercepting a communication representing a transaction between a client and a service along a network;
interpreting said communication to determine details of said transaction;
determining if said transaction complies with policy based on said details of said transaction; and
remediating where said transaction is determined to not comply with said policy.

2. The method of claim 1, wherein said service is a web service.

3. The method of claim 1, wherein said client is a client of a consumer.

4. The method of claim 1, wherein said service is a service of a provider.

5. The method of claim 1, wherein said network is a secure network backbone.

6. The method of claim 1, wherein said communication is an ordered message exchange.

7. The method of claim 1, wherein said communication conforms to XML standards.

8. The method of claim 1, wherein said communication conforms to SOAP standards.

9. The method of claim 1, wherein said communication conforms to HTTP standards.

10. The method of claim 1, wherein said policy comprises management policy.

11. The method of claim 1, wherein said policy comprises security policy.

12. The method of claim 1, wherein said step of remediating comprises blocking said communication.

13. The method of claim 1, wherein said step of remediating comprises logging said determination of non-compliance.

14. The method of claim 1, wherein said step of remediating comprises modifying said communication to produce a communication that represents a transaction that complies with said policy.

15. The inethod of claim 1, wherein said policy comprises rules and events, wherein said events may be executed based on said rules.

16. A system for managing policy in a service-oriented architecture, comprising:
a policy client sensor for intercepting a communication representing a transaction between a client and a service along a network;
a policy engine for interpreting said communication to determine details of said transaction and determining if said transaction complies with policy based on said details of said transaction; and
a policy client actuator for remediating where said transaction is determined to not comply with said policy.

17. The system of claim 16, wherein said service is a web service.

18. The system of claim 16, wherein said client is a client of a consumer.

19. The system of claim 16, wherein said service is a service of a provider.

20. The system of claim 16, wherein said network is a secure network backbone.

21. The system of claim 16, wherein said communication is an ordered message exchange.

22. The system of claim 16, wherein said communication conforms to XML standards.

23. The system of claim 16, wherein said communication conforms to SOAP standards.

24. The system of claim 16, wherein said communication conforms to HTTP standards.

25. The system of claim 16, wherein said policy comprises management policy.

26. The system of claim 16, wherein said policy comprises security policy.

27. The system of claim 16, wherein said policy client actuator blocks said communication where said transaction is determined to not comply with said policy.

28. The system of claim 16, wherein said policy client actuator logs said determination of non-compliance where said transaction is determined to not comply with said policy.

29. The system of claim 16, wherein said policy client actuator modifies said communication to produce a communication that represents a transaction that complies with said policy where said transaction is determined to not comply with said policy.

30. The system of claim 16, wherein said policy comprises rules and events, wherein said events may be executed based on said rules.

31. A computer system comprising:
a processor; and
a computer recording medium including computer executable code executable by the processor for managing policy in a service-oriented architecture, the computer executable code comprising:
code for intercepting a communication representing a transaction between a client and a service along a network;
code for interpreting said communication to determine details of said transaction;
code for determining if said transaction complies with policy based on said details of said transaction; and
code for remediating where said transaction is determined to not comply with said policy.

32. The computer system of claim 31, wherein said service is a web service.

33. The computer system of claim 31, wherein said client is a client of a consumer.

34. The computer system of claim 31, wherein said service is a service of a provider.

35. The computer system of claim 31, wherein said network is a secure network backbone.

36. The computer system of claim 31, wherein said communication is an ordered message exchange.

37. The computer system of claim 31, wherein said communication conforms to XML standards.

38. The computer system of claim 31, wherein said communication conforms to SOAP standards.

39. The computer system of claim 31, wherein said communication conforms to HTTP standards.

40. The computer system of claim 31, wherein said policy comprises management policy.

41. The computer system of claim 31, wherein said policy comprises security policy.

42. The computer system of claim 31, wherein said code for remediating comprises code for blocking said communication.

43. The computer system of claim 31, wherein said code for remediating comprises code for logging said determination of non-compliance.

44. The computer system of claim 31, wherein said code for remediating comprises code for modifying said communication to produce a communication that represents a transaction that complies with said policy.

45. The computer system of claim 31, wherein said policy comprises rules and events, wherein said events may be executed based on said rules.

46. A computer recording medium including computer executable code for managing policy in a service-oriented architecture, the computer executable code comprising:
code for intercepting a communication representing a transaction between a client and a service along a network;
code for interpreting said communication to determine details of said transaction;
code for determining if said transaction complies with policy based on said details of said transaction; and
code for remediating where said transaction is determined to not comply with said policy.
